(19) United States
(12) Patent Application Publication
(10) Pub. No.: US 2012/0271665 A1
(43) Pub. Date: Oct. 25, 2012

(54) PROVIDING TARGETED CONSIDERATION AND INCENTIVE GENERATION OF A TICKETED ITEM IN A SOCIAL ENVIRONMENT

(76) Inventor: BALAGANGADHAR MUSRIF, Fremont, CA (US)

(21) Appl. No.: 13/090,296

(22) Filed: Apr. 20, 2011

(51) Int. Cl. G06Q 30/00; G06Q 10/00

(52) U.S. Cl. 705/5

(57) ABSTRACT

Systems and methods of tracking a further reservation of a ticketed item to a first user when a second user provides payment of the ticketed item to a payment portal are disclosed. In one or more embodiments, the method also includes automatically generating a discount, a discounted price for the ticketed item and/or a refund of the ticket price to the first user based on a value for a promotional success of the first user. The method further includes analyzing at least one of a number of further reservations achieved through a unique identification data associated with the first user and the number of visits through the unique identification data associated with the first user to calculate the promotional success of the first user.

### FIELD OF TECHNOLOGY

This disclosure relates to providing targeted consideration and incentive generation of a ticketed item in a social environment.

### BACKGROUND

A seller of a ticketed item (e.g. an even organizer, a merchant, a retailer, a wholesaler, a show organizer, a hotel hosting an event, a private party hosting an event etc.) may want to advertise the ticketed item to a wide audience using a network. The seller may want to promote the ticketed item widely to a large number of buyers (e.g. attendees, customers, retailers etc.) The seller may want to rapidly promote the ticketed item and reach out to a wide audience. The seller may not be aware of a demographic of a certain location, and may be unable to sell out the ticketed item without advertising in that particular location. The seller may not have any means to target a group of similar minded individuals that may be interested in the ticketed item. The seller may not be able to adequately promote the ticketed item using conventional means such as creating posters advertising the ticketed item, posting details associated with the ticketed item on a website and/or mailing a set of details associated with the ticketed item. The seller may not be able to actively perpetrate a social circle of a potential buyer even if the potential buyer's friends may be interested in the ticketed item. The potential buyer, on the other hand, may be interested in purchasing the ticketed item but may have no incentive to promote the ticketed item to the social circle. The seller may be crippled by conventional methods and may not be able to adequately find a market for the ticketed item. The seller may also have to spend a large amount of time and money in trying to promote the ticketed item using such conventional methods. In doing so, the seller may lose valuable time and money in promoting the ticketed item and may be unable to find the right audience for the ticketed item.

### SUMMARY

This disclosure relates to providing targeted consideration and incentive generation in a ticket management environment.

In one aspect, the method includes publishing, through a management server, a set of reservation details associated with a ticketed item. The method also includes reserving the ticketed item for a first user when the first user provides payment of the ticketed item to a payment portal through the management server. Further, the method includes generating a first unique identification data associated with the first user on an availability notification of the ticketed item for the first user to publish on a social network. The method further includes tracking a further reservation of the ticketed item achieved when a second user, who is a member of the social network, purchases the ticketed item through the first unique identification data associated with the first user. The method may also include calculating a value for a promotional success of the first user based on at least one of a number of further reservations tracked through the first unique identification data associated with the first user and the number of visits to the management server through the first unique identification data associated with the first user. The method also includes automatically generating, through the payment portal, a discount to the first user based on the value of the promotional success of the first user.

The method also includes when the second user purchases the ticketed item through the unique identification data associated with the first user, generating a second unique identification data associated with the second user that also contains the first unique identification data associated with the first user. The method may also include tracing a further reservation of the ticketed item by a third user, who is a member of a social network of the second user, to the first user through the second unique identification data that also contains the first unique identification data associated with the first user. The method may further include increasing the value for the promotional success of the first user and the second user based on the further reservation of the ticketed item by the third user.

The method may further include generating a calculated promotional potential of the user based on at least one of a social media worth of the user, a number of contacts at a social media website, a frequency of activity on a social media website, a reputation of the user on the social media website, a number of followers of the user on the social media website, a frequency of visits to the management server, an information obtained from a third party social media analyzer evaluating a social media worth of the user, a number of ticketed items sold through the user, a set of interests associated with the user, a social clout value, a calculated loyalty of the user and other predetermined factors

The method may also include retrieving a social media credential information of the first user. The method may further include analyzing, through an analysis module, a promotional potential of the first user based on the social media credential information. The method may also include generating a calculated promotional potential of the first user. Further the method may include generating an optimized promotional plan for the first user based on the analysis and the calculated promotional potential of the first user.

The optimized promotional plan may be at least one of prompting the first user to publish the first unique identification data on a particular social network at a predetermined interval of time and an automatic publishing of the first unique identification data on the availability notification of the ticketed item on the particular social network.

The method further includes setting a predetermined duration for the further reservation of the ticketed item through the management server. The method also includes increasing the value for the promotional success of the first user when the further reservation occurs within the predetermined duration. The method may also include keeping the value for the promotional success of the first user the same when the further reservation occurs after the predetermined duration.

The method also includes when the value for the promotional success of the first user is greater than a threshold value, converting the discount to a refund of a purchase price of the ticketed item. The method also includes automatically generating the refund, through the payment portal.

The unique identification data may be at least one of a unique URL, a unique web source, a redemption code and a unique bar code or a QR code.

The discount to the first user may be at least one of a fixed percentage of the ticket price, a sliding scale percentage based on the ticket price and the value for the promotional success, a credit, a refund of the purchase price of the ticketed item, a predetermined coupon value, a rewards certificate and a predetermined fixed value.

The method also includes creating an account for the first user when the first user reserves the ticketed item on the management server. The method may also include tracking at least one of a number of further reservations and a number of visits to the management server through the unique identification information associated with the first user. The method further includes evaluating the promotional success associated with the first user over a period of time. Further, the method includes generating a rewards ticket based on a value of the promotional success of the first user.

The method may also include dynamically modifying the promotional success of the first user based on the number of further reservations. The method also includes generating the value for the promotional success of the first user at the end of the predetermined duration. The method may also include generating a discount to the first user based on the promotional success of the first user and the end of the predetermined duration.

The method also includes automatically determining an availability of a remainder of ticketed items based on a number of reservations.

In another aspect, a method may also include reserving a ticketed item for a first user when the first user reserves the ticketed through a management server. The method may also include generating a first unique identification data associated with the first user on an availability notification of the ticketed item for the first user to publish on a social network. The method further includes tracking a further reservation of the ticketed item achieved when a second user, who is a member of the social network, purchases the ticketed item through the first unique identification data associated with the first user. Also, the method may include calculating a value for a promotional success of the first user based on at least one of a number of further reservations tracked through the first unique identification data associated with the first user and the number of visits to the management server through the first unique identification data associated with the first user. The method includes automatically generating a discounted price, through the payment portal, based on the value of the promotional success of the first user when the first user purchases the ticketed item.

In yet another aspect, a system comprising a processor communicatively coupled with a volatile memory and a non-volatile storage includes a management server and a payment portal. The management server publishes a set of reservation details associated with a ticketed item. The management server also reserves the ticketed item when requested by a first user. The management server generates a unique identification information associated with the first user. The management server tracks at least one of a number of further reservations of the ticketed item through the unique identification information associated with the first user and a number of further visits to the management server through the unique identification information associated with the first user. The management server also calculates a value for a promotional success of the first user based on at least one of a number of further reservations of the ticketed item and a number of further visits to the management server through the unique identification information associated with the first user.

The payment portal may automatically generate a discount to the first user based on the value of the promotional success of the first user. The payment portal may automatically generate a discounted price based on the value of the promotional success of the first user when the first user purchases the ticketed item. The management server may also generate a calculated promotional potential of the user based on at least one of a social media worth of the user, a number of contacts at a social media website, a frequency of activity on a social media website, a reputation of the user on the social media website, a number of followers of the user on the social media website, a frequency of visits to the management server, an information obtained from a third party social media analyzer evaluating a social media worth of the user, a number of ticketed items sold through the user, a set of interests associated with the user, a social clout value, a calculated loyalty of the user and other predetermined factors.

### BRIEF DESCRIPTION OF THE DRAWINGS

Example embodiments are illustrated by way of example and not limitation in the figures of the accompanying drawings, in which like references indicate similar elements and in which:

FIG. 1 illustrates an interaction flow overview of the management server and the payment in relation to the various users of the system.

FIG. 2 is a detailed view of the system showing a generation of a discount to the first user.

FIG. 3A to 3F illustrate a visual path flow of the method.

FIG. 4 illustrates a conversion of a discount to a refund.

FIGS. 5A and 5B illustrate the tracking of the unique identification information of multiple users in the system.

### DETAILED DESCRIPTION

This disclosure relates to providing targeted consideration and incentive generation of a ticketed item in a social environment. In the following description, for the purposes of explanation, numerous specific details are set forth in order to provide a thorough understanding of the various embodiments. It will be evident, however, to one skilled in the art that the various embodiments may be practiced without these specific details.

### System Overview

The application discloses methods that center around providing incentives to promote a sale of a ticketed item in one or more embodiments. The incentive may be in the form of a discount of a ticketed item, a discounted price for the ticketed item and/or a refund of the ticketed item price in one or more embodiments. The ticketed item may be a ticket to an event, an ongoing sale at a retail store, a sale of a particular item at a retail store, a direct sale of an item such as airline ticket and/or hotel reservation and/or service etc. The seller of a ticketed item may want to publish a set of reservation details associated with the ticketed item on a management server to increase publicity and promotion of the ticketed item in one or more embodiments. The management server may include a tracking module and an analysis module to gather a set of data associated with the ticketed item and to analyze and track a set of users accessing the management server. The management server may also be linked to a payment portal that may enable users of the system to pay for the ticketed item.

A first user of the management server may view a set of reservation details associated with the ticketed item on the management server, in one or more embodiments and may be interested in purchasing the ticketed item. The first user may access the management server through a social media credential information, in one or more embodiments. The first user may decide to purchase the ticketed item and pay a ticket price associated with the ticketed item to the payment portal in one or more embodiments. In one or more embodiments, the management server may produce a receipt of the transaction to the first user. The management server may also generate a unique identification information associated with the first user in one or more embodiments. In one or more embodiments, the management server may place the unique identification information on an availability notification of the ticketed item. The first user may publish the availability notification on his/her social media page to further promote the item to his friend on the social media website. In one or more embodiments, the management server may indicate to the first user that the first user may receive a discount or refund of the ticket price associated with the ticketed item if the first user is able to provide more purchasers of the ticketed item. In one or more embodiments, the management server may provide an optimized promotional plan and ask the first user to publish the availability notification on all his social networks. In one or more embodiments, the management server may be able to extract a set of social media credentials associated with the first user. The management server may analyze, through the analysis module, a promotional potential of the first user in one or more embodiments. In one of more embodiments, the management server may generate the optimized promotional plan based on the promotional potential of the first user.

A second user may be a member of the social media or social network of the first user in one or more embodiments. In one or more embodiments, the second user may view the availability notification of the ticketed item on the social network and may click on the availability notification. The second user may be directed to the management server though the unique identification information associated with the first user in one or more embodiments. In one or more embodiments, the second user and other users of the social network associated with the first user may purchase the ticketed item when directed to the management server through the unique identification information associated with the first user. In one or more embodiments, the management server may create an account for the first user and track a set of reservation activity derived from the unique identification information associated with the first user. In one or more embodiments, the management server may evaluate a promotional success of the first user and may generate a value for the promotional success through the analysis module and the tracking module. In one or more embodiments, the management server may, through the payment portal, generate a discount to the first user based on the value for the promotional success of the first user

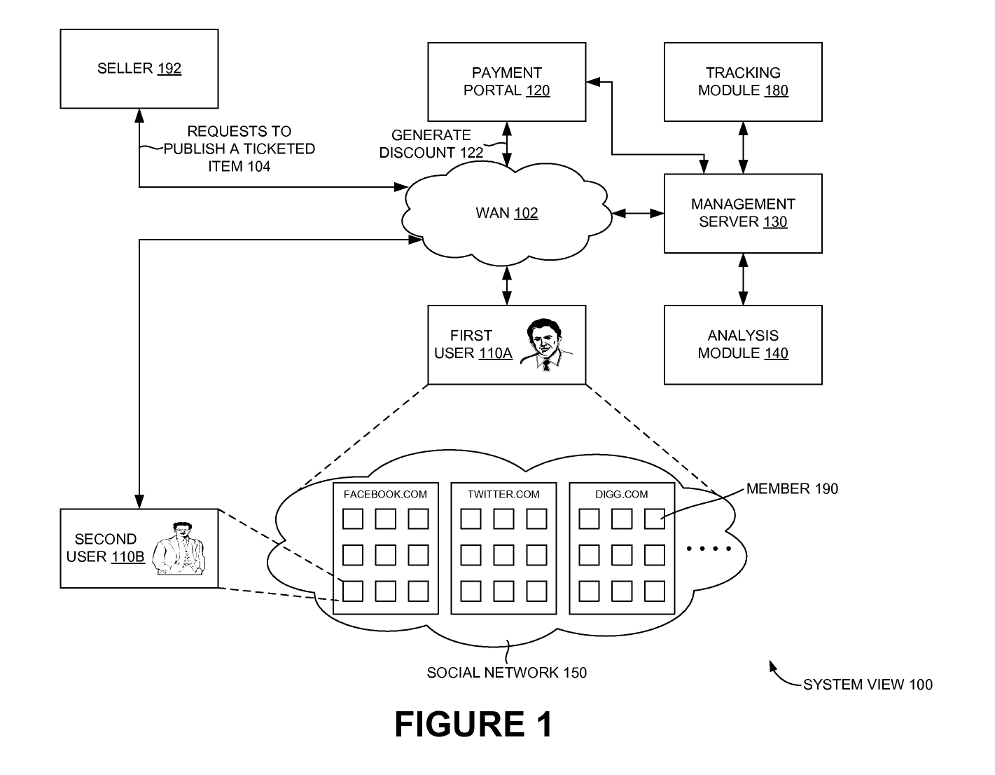

FIG. 1 describes the interaction between the first user 110A, the second user 110B, a social network 150, a member of the social network 190, a wide area network (WAN) 102, the management server 130, the payment portal 120, a discount 122, the tracking module 180 and the analysis module 140.

Based on a request of a seller of a ticketed item, the management server 130 may publish a set of reservation details associated with the ticketed item in one or more embodiments. The management server 130 may be connected to a processor and a memory in one or more embodiments. The management server may also include a user interface. In one or more embodiments, the management server may be connected to the seller, the analysis module 140, the tracking module 180, the first user 110 A, the social network 150 associated with the first user 110 A and the second user 110 through a wide area network (WAN) 102. The social network 190 may be one of many social networks that enable users to communicate with other users. For example, the social network 150 may be Facebook®, Twitter®, MySpace®, Digg®, Friendster®, and any other social network. The social network 150 may have many members 190 who may be associates or friends of the first user 110 A in one or more embodiments. In one or more embodiments, the second user 110 B may be a member 190 of the social network 150 associated with the first user 110 A.

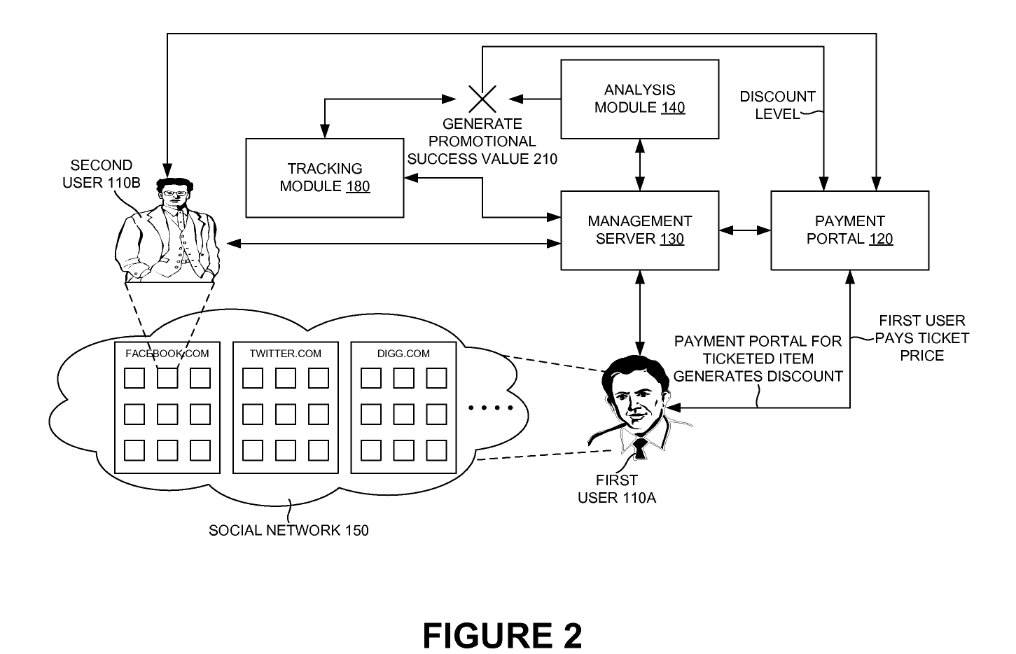

FIG. 2 is a detailed view that illustrates the relationship between the first user 110 A, the second user 110 B, the social network 150, the tracking module 180, the promotional success value 210, the analysis module 140, the management server 130 and the payment portal 120.

In one or more embodiments, the first user 110 A may pay a ticket price associated with the ticketed item to the payment portal 120 after viewing a set of reservation details associated with the ticketed item on the management server 130. For example, the first user 110 A may have viewed a ticketed item advertising a concert ticket for $100. In another embodiment, the first user 110 A may view the set of reservation details associated with the ticketed item on the management server, but may not purchase the ticketed item. Instead, the first user 110 A may be interested in promoting the ticketed item through his social media network in hopes of maybe obtaining the ticketed item at a discounted price. In one or more embodiments, the first user 110 A may have accessed the management server through a social media website such as Facebook®, Twitter®, MySpace®, Digg®, Friendster®, and any other social network. Upon receipt of payment of a ticket price associated with the ticketed item, the management server 130 may be able to access a set of social media credential information associated with the first user 110 A in one or more embodiments. For example, the first user 110 A may have registered to the management server using his account on Facebook. The management server 130 may then be able to access the Facebook® account associated with the first user 110 A in one or more embodiments. In one or more embodiments, the analysis module 140 may then analyze the promotional potential of the first user 110 A by analyzing a set of information obtained through the Facebook® account associated with the first user 110 A. For example, the analysis module 140 may take into account that the first user 110 A has 200 friends on Facebook® or analyze the frequency of activity of the user on Facebook® or a number of other factors. In another example, the analysis module may analyze the first user's level of activity on Facebook® in conjunction with the first user's level of activity on other social media websites such as Twitter ® and other social networks. In one or more embodiments, the analysis module may take into account the social media worth of the user, a number of contacts at a social media website, a frequency of activity on a social media website, a reputation of the user on the social media website, a number of followers of the user on the social media website, a frequency of visits to the management server, an information obtained from a third party social media analyzer evaluating a social media worth of the user, a number of ticketed items sold through the user, a set of interests associated with the user, a social clout value, a calculated loyalty of the user and other predetermined factors to determine the promotional potential of the first user 110 A. In one or more embodiments, the management server may request other social media credential information from the first user 110 A to increase chances of promotions for the first user 110 A. In one or more embodiments, the management server 130 may access the social media credential information associated with the first user 110 A prior to payment of ticket price to the payment portal 120 or after payment of ticket price to the payment portal 120. When the first user 110 A has provided payment for the ticketed item to the payment portal 120, the management server may generate a unique identification information associated with the first user 110 A on an availability notification of the ticketed item in one or more embodiments. For example, the unique identification information may be a unique URL, a unique identification page, a redemption code or any other uniquely identifying tag. In another embodiments, the first user 110 A may not have paid the ticket price of the ticketed item to the payment portal 120 but may be interested in promoting the ticketed item to his social network in hopes of getting a discounted price for the ticketed item. For example, the first user 110 A may request the management server 130 to create a unique identification information for the first user 110 A. The management server 130 may generate the unique identification information for the first user 110 A that the first use 110 A may then publish on a set of social networks.

In one or more embodiments, after the first user 110 A has provided payment for the ticketed item to the payment portal 120 and the analysis module has analyzed the promotional potential of the first user 110 A, the management server 130 may generate an optimized promotional plan for the first user 110 A. In another embodiment, even if the first user 110 A has not provided payment to the payment portal 120, but if the first user 110 A has requested a unique identification information from the management server 130, the management server 130 may analyze the promotional potential of the first user 110 A as per the social media credential information associated with the first user 110 A and the generate the optimized promotional plan for the first user 110 A. For example, according to the optimized promotional plan, the management server 130 may prompt the first user 110 A to publish the availability notification on a particular social network. The management server 130 may have analyzed that a set of friends on Facebook® are most active between 9 AM to 10 AM. Consequently, the management server 130 may prompt the first user 110 A to publish the availability notification at 9 AM on Facebook®. Similarly, the optimized promotional plan may include a frequency at which the first user 110 A may publish the availability notification on Facebook® or Twitter® to guarantee a higher likelihood of success for promotion. In one or more embodiments, based on a preference of the first user 110 A, the management server 130 may automatically publish the availability notification on various social networks associated with the first user 110 A according to the optimized promotional plan. For example, the first user 110 A may have set the preference of optimized promotional plan to “automatic,” and the management server 130 may publish the availability notification every 5 hours based on the analysis of analysis module 140 and the optimized promotional plan. In another example, the first user 110 A may have set the preference of optimized promotional plan to “manual,” and the management server 130 may simply prompt the first user 110 A by email or any other preferred mode of communication, suggesting that the first user 110 A manually publish the availability notification on various social network pages associated with the first user 110 A.

In one or more embodiments, the first user 110 A may publish the availability notification on a set of social networks. For example, the first user 110 A may publish the availability notification on Facebook® and Twitter®. The second user 110 B may be a member of the social network associated with the first user 110 A. For example, the second user 110 B may be a “friend” of first user 110 A on Facebook®. The second user 110 B may click on the availability notification and may be directed to the management server 130 through the unique identification information in one or more embodiments. In one or more embodiments, the second user 110 B may decide to purchase the ticketed item and may pay the ticket price associated with the ticketed item to the management server 130 through the payment portal 120. In another embodiment, the second user 110 B may visit the management server 130 through the unique identification information associated with the first user 110 A but may not purchase the ticketed item. In one or more embodiments, the tracking module 180 may track a set of activity associated with the first user 110 A and/or the unique identification information associated with the first user 110 A.

In one or more embodiments, the tracking module 180 may create an account 380 for the first user 110 A and may keep track of a number of further reservations achieved through the unique identification information associated with the first user 110 A and/or a number of visits to the management server 130 through the unique identification information associated with the first user 110 A. For example, when the second user 110 B visits the management server 130 through the unique identification information associated with the first user 110 A, the tracking module 180 may denote the visit in the account 380 associated with the first user 110 A. In another example, when the second user 110 B purchases the ticketed item after being directed to the management server 130 through the unique identification information associated with the first user 110 A, the tracking module 180 may denote the visit in addition to the purchase of the ticket and denote the purchase as a “further reservation” of the ticketed item. In one or more embodiments, the tracking module 180 may track a number of further reservations achieved through the unique identification information associated with the first user 110 A and a number of visits to the management server 130 and may store the information in the account 380 associated with the first user 110 A. For example, if the unique identification information associated with the first user 110 A led to 4 further reservations of the ticketed item, and 80 visits to the management server, the tracking module may track the further reservations and the number of visits and store the information in the account 380 associated with the first user 110 A.

In one or more embodiments, the tracking module 180 may only track the further reservation and the number of visits to the management server 130 when the further reservation and/or visit to the management server 130 occurs within a predetermined duration set by the management server 130. For example, the management server 130 may have set the predetermined duration for the further reservation activity to be a period of 48 hours. The tracking module may only track the further reservations of the ticketed item and the number of visits to the management server 130 through the unique identification information of the first user 110 A for a period of 48 hours of when the management server 130 generated the availability notification of the ticketed item. The predetermined duration may be a set period of time set by the management server. In another example, the predetermined duration may begin when the seller of the ticketed item first publishes a set of reservation details on the management server 130. In this case, if the management server sets the predetermined duration to be 48 hours and if the management server 130 generates the availability notification of the ticketed item 6 hours after the time that the management server published the set of reservation details associated with the ticketed item, the tracking module may only track the number of further reservations and a number of visits to the management server through the unique identification information associated with the first user 110 A for a period of 42 hours after the availability notification for the first user 110 A was generated.

In one or more embodiments, after the predetermined duration set by the management server 130 has ended, the tracking module may tally a set of total further reservations and a number of visits achieved through the unique identification information associated with the first user 110 A. For example, the tracking module may find that at the end of the 48 hours, the unique identification information associated with the first user 110 A produced 4 further reservations and 80 visits to the management server.

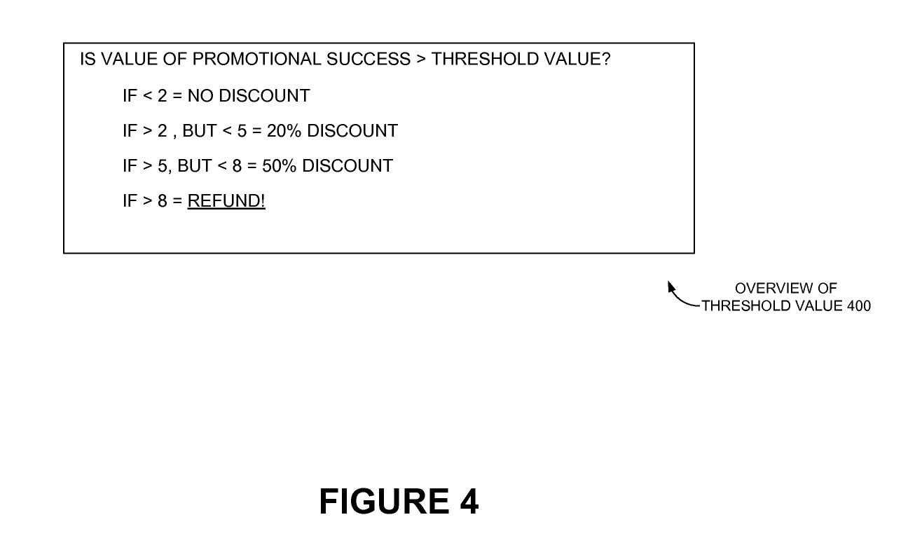

In one or more embodiments, the analysis module 140 may communicate with the tracking module 180 to calculate a value for the promotional success of the first user 110 A (denoted as “X” in Figures). In one or more embodiments, the analysis module may have a set of parameters to help calculate the value of the promotional success of the first user 110 A. In one or more embodiments, the value for the promotional success may be a function of the number of further reservations achieved through the unique identification information associated with the first user 110 A and a number of visits to the management server 130 through the unique identification information associated with the first user 110 A. For example, the value for the promotional success of the first user 110 A may be a value between 1 and 10. In another example, the value for the promotional success of the first user 110 A may be a percentage. In yet another example, the value for the promotional success of the first user 110 A may be a range. The parameters used to calculate the promotional success value may be automatically determined through the management server 130 or may be customized by an administrator of the management server 130 in one or more embodiments. In one or more embodiments, the analysis module may assign a weight to the further reservation and to the number of visits to the management server through the unique identification information associated with the first user 110A. For example, the analysis module may place a higher weight for further reservations since they generate income, and may place a lower weight for number of visits achieved. For example, the analysis module may have assigned a weight of 0.95 to further reservations achieved through the unique identification information associated with the first user, and a weight of 0.05 to a number of visits to the management server through the unique identification information associated with the first user. If the number of further reservations is 4 and the number of visits is 80, the analysis module may calculate the value for promotional success using percentages of visits and further reservations. In this example, the percentage of further reservations may be [4/(80+4)]×(0.95) and the percentage of number of visits may be [80/(80+4)]×(0.05). In total, the value generated may be 0.08 in this particular example. The analysis module 140 may then use the value of the promotional success to determine a discount level for the first user. In one or more embodiments, discount to the first user may be at least one of a fixed percentage of the ticket price, a sliding scale percentage based on the ticket price and the value for the promotional success, a credit, a refund of the purchase price of the ticketed item, a predetermined coupon value, a rewards certificate and a predetermined fixed value. For example, the if the values for the promotional success of the first user 110 A fall between a range of 1 to 10, the analysis module may have a predetermined criteria that may determine a discount level for the first user 110 A (FIG. 4).

In one or more embodiments, the analysis module may have a threshold value, either set by the management server 130 or customized through an administrator of the management server 130 such that a value for promotional success greater than the threshold value generates a refund of the ticket price to the first user 110 A. In one or more embodiments, the discount level for the first user 110 A may be determined by the value of the promotional success. For example, if the value of promotional success if <2, no discount may be applicable. If the value is >2 but <5, the analysis module 140 may communicate with the payment portal 120 and may generate a discount of 20% of the ticket price of the ticketed item to the first user 110 A. If the value of promotional success if >5 but <8, the analysis module 140 may communicate with the payment portal 120 and may generate a discount of 50% of the ticket price of the ticketed item to the first user 110 A. Finally, in this example, the analysis module may have set the threshold value at 8, and if the value is >8, the analysis module 140 may communicate with the payment portal 120 and may generate a refund of the ticket price of the ticketed item to the first user 110 A.

In one or more embodiments, if the first user 110 A already purchased the ticketed item, the payment portal 120 may generate a discount based on the value of the promotional success. For example, if the value for the promotional success of the first user 110 A is calculated to be 5.5, the payment portal may automatically generate a discount of $50 on a ticket price of $100 as per the example in FIG. 4 that may automatically be deposited to the first user 110 A. In another embodiment, if the first user 110 A did not purchase the ticketed item, but simply requested that an availability notification of the ticketed item be generated, the first user 110 A may have the option to purchase the ticketed item at a discounted price. For example, in this case if the value for the promotional success if 5.5 again, the first user may then purchase the ticketed item for $50 instead of $100 and may the provide payment to the payment portal.

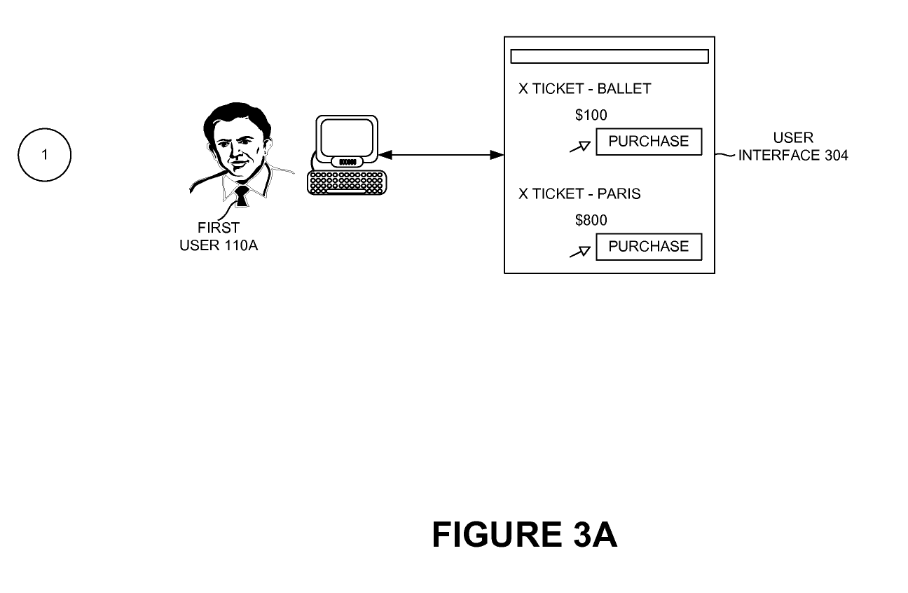

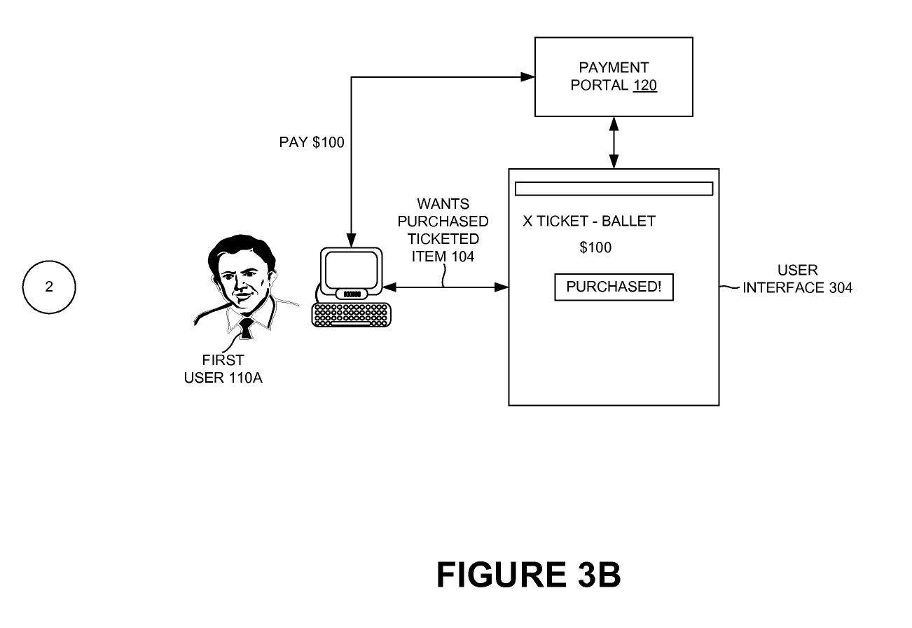

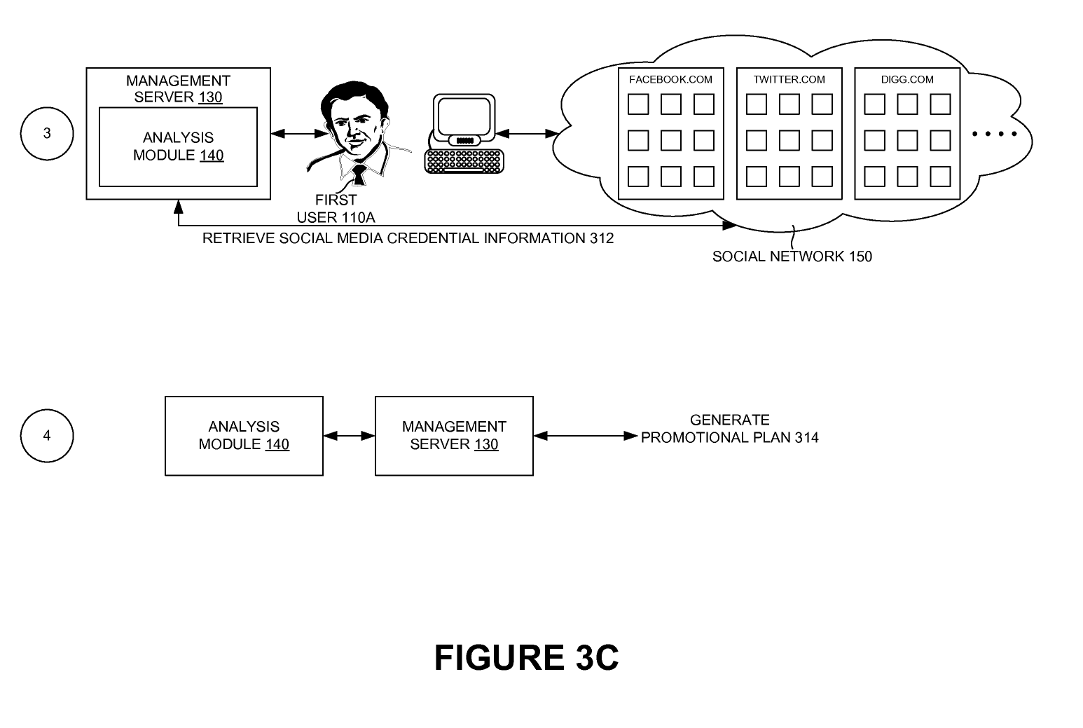

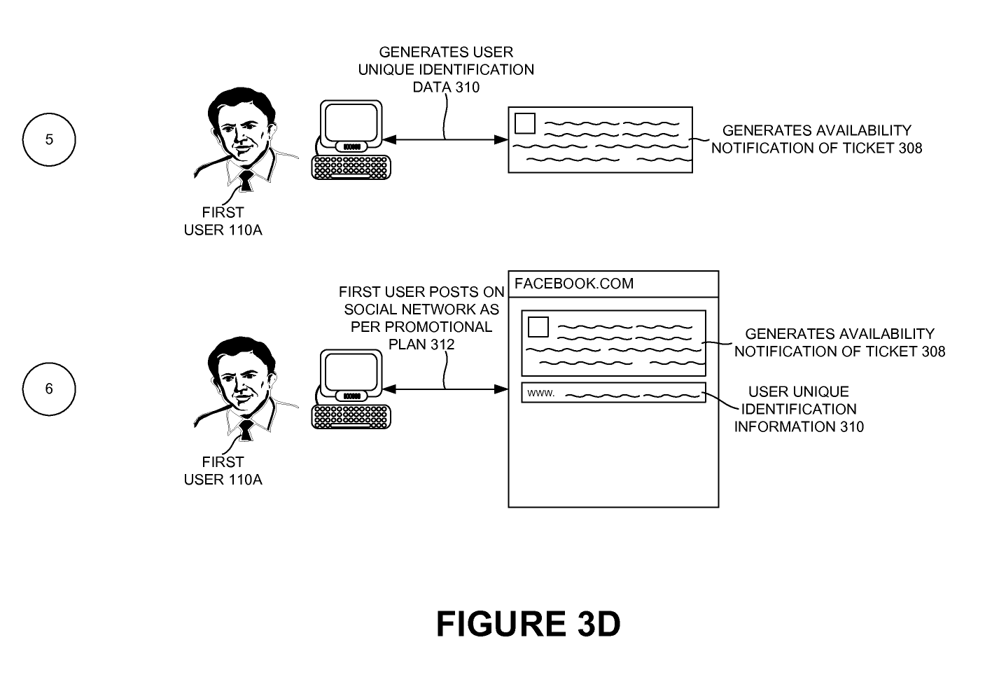

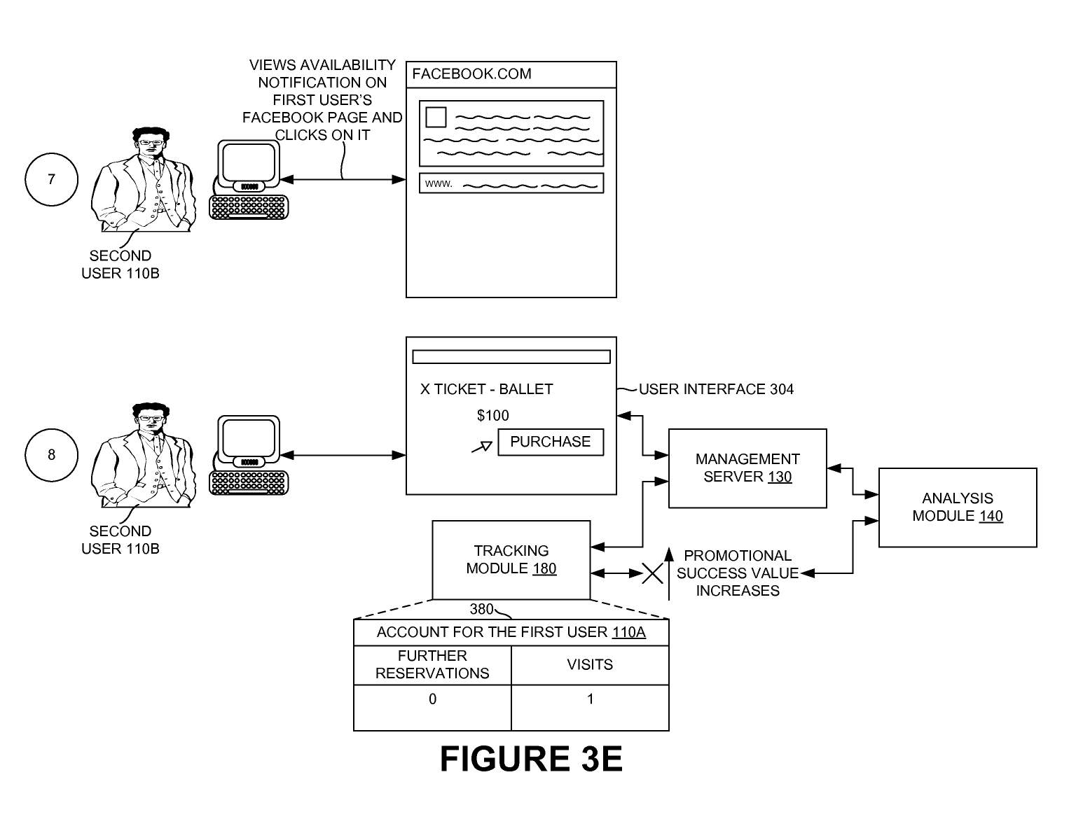

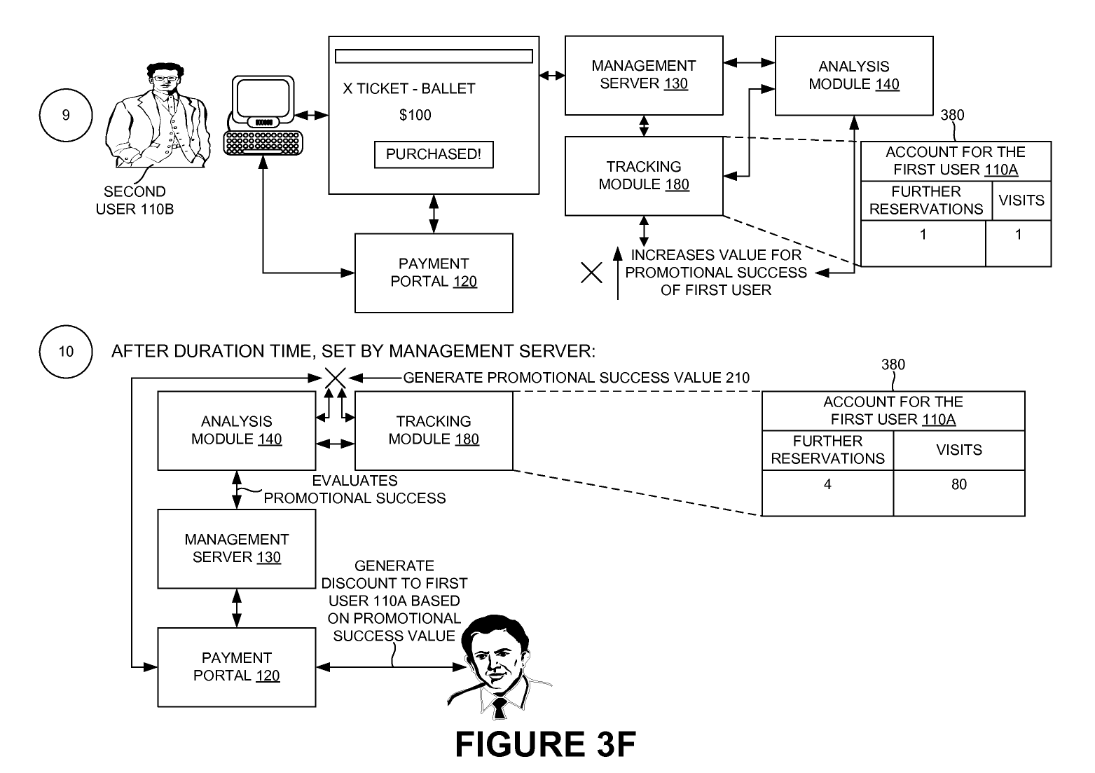

FIGS. 3A to 3F is a visual path flow diagram that illustrates the method in a step by step approach.

In step 1 of FIG. 3A, the first user 110 A may view the user interface 304 of the management server 130 through a data processing unit. The data processing unit may be a laptop, a cell phone a smart phone, a desktop computer or any other data processing unit. The first user 110 A may have accessed the management server 130 and may have viewed a number of ticketed items on the management server. For example, the first user 110 A may see a ticketed item for $100 for a ticket to the ballet, or a ticket for $800 for a flight ticket to Paris. Depending on his interest, the first user may select to purchase the $100 ticket to the Ballet.

In step 2 of FIG. 3B, the first user 110 A may pay the ticket price of $100 to the management server 130 through the payment portal 120, in this particular example.

In step 3 of FIG. 3C, the analysis module 140 and the management server 130o may retrieve a set of social media credential information 312 associated with the first user 110 A and may access a social network 150 associated with the first user 110 A.

In step 4 of FIG. 3C, the analysis module may analyze the social media credential information 312 of the first user 110 A and may generate an optimized promotional plan 314 for the first user 110 A.

In step 5 of FIG. 3D, the first user 110 A may generate a user identification data 310 associated with the first user 110 A and an availability notification 308 of the ticketed item.

In step 6 of FIG. 3D, the management server 130 may prompt the first user 110 A to publish the availability notification 308 on Facebook® based on the promotional plan 314. Prompted by the managements server 130, the first user 110 A may publish the availability notification on Facebook®. The availability notification may contain the user identification data 310.

In step 7 of FIG. 3E, the second user 110B who may be a “friend” of the first user 110 A on Facebook® may view the availability notification on the first user 110 A's page. The second user may click on the unique identification data 310 and may be directed to the management server 130.

In step 8 of FIG. 3E, the second user may view the ticketed item to the Ballet. When the second user 110 B visits the management server 130 through the unique identification data 310, the tracking module 180 may track the activity and store the information in the account 380 associated with the first user 110 A. This may slightly increase the value for the promotional success (“X”) for the first user 110 A that will be calculated by the analysis module 140 at the end of the predetermined duration set by the management server 130.

In step 9 of FIG. 3F, the second user 110B may decide to purchase the ticketed item to the Ballet. The second user 110 B may pay the ticket price of $100 to the payment portal 120. The tracking module may track this further reservation into the account 380 of the first user 110 A. This may slightly increase the value for the promotional success (“X”) for the first user 110 A that will be calculated by the analysis module 140 at the end of the predetermined duration set by the management server 130.

In step 10 of FIG. 3F, the predetermine duration set by the management server 130 may have elapsed. The tracking module may communicate the number of further reservations achieved through the unique identification information associated with the first user 110 A and the number of visits to the management server through the unique identification information associated with the first user 110 A. The analysis module 140 may then analyze this information and may generate the value for the promotional success (“X”) of the first user 110 A. The analysis module 140 may communicate this value 210 to the payment portal that may automatically generate a discount to the first user 110 A based on the value 210. Based on the value of the promotional success 210, the discount may be zero, a percentage value of the ticket price or a refund of the entire ticket price.

FIG. 4 illustrates the overview of the threshold value as discussed above. In one or more embodiments, the analysis module may determine the threshold value such that when the value 210 for the promotional success of the first user 110 A is greater than the threshold value, the first user 110 A either receives a refund of the ticket price of the ticketed item, or receives the ticketed item for free.

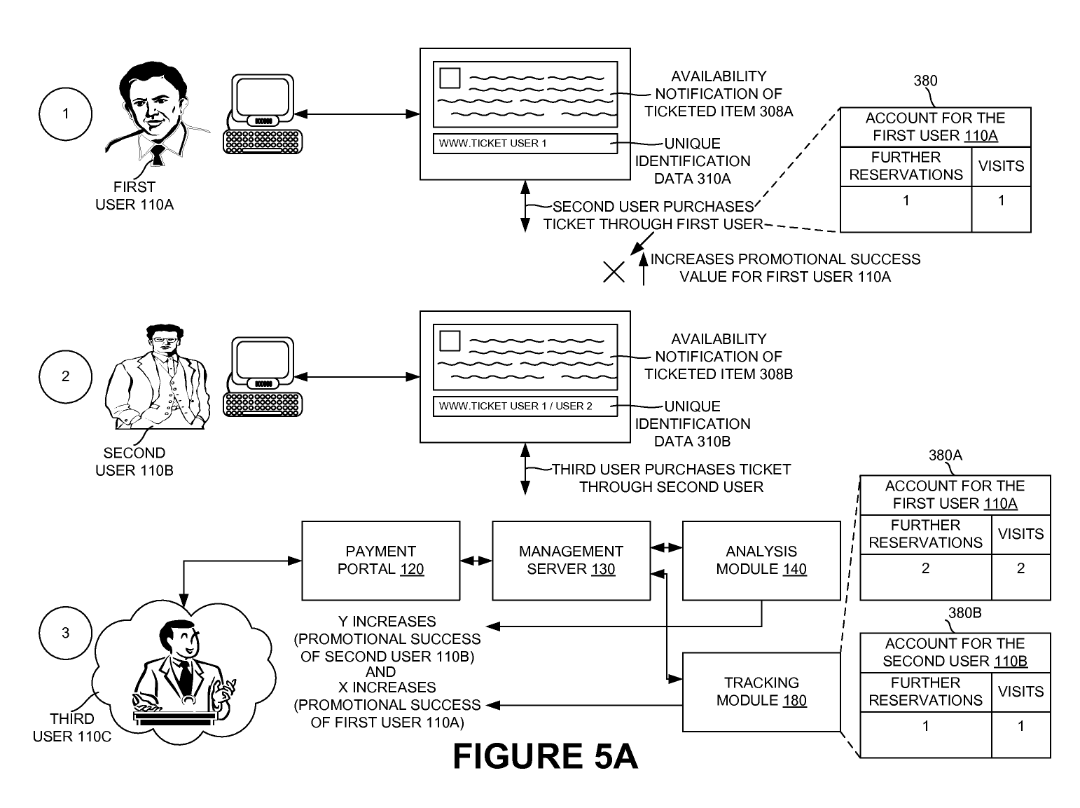

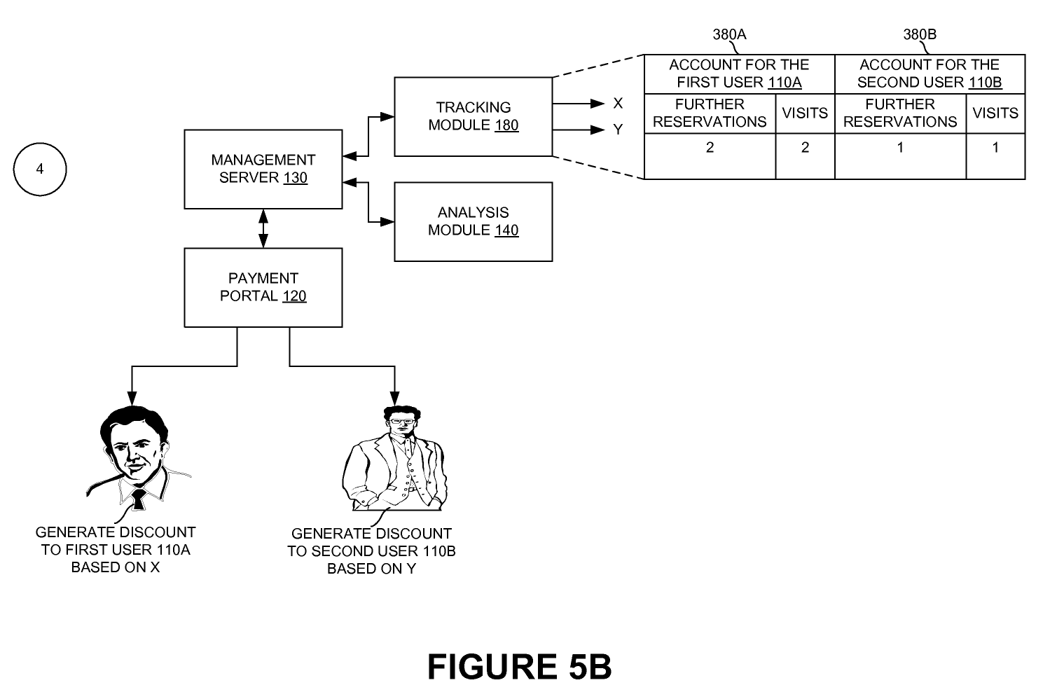

FIGS. 5A and 5B illustrate how the unique identification information may be tacked on by multiple users of the system.

In step 1 of FIG. 5A, the management server 130 may generate a unique identification data 310A associated with the first user 110 A on the availability notification of the ticketed item 308A that the first user 110 A may publish on his Facebook® page. The second user 110B may purchase the ticketed item through the unique identification information 310 A. The tracking module may track the further reservation and store the information into the account 380 associated with the first user 110 A.

In step 2 of FIG. 5A, the management server 130 may generate a second unique identification data 310 B associated with the second user 110B on the availability notification of the ticketed item 308B. The unique identification data 310 B associated with the second user 110 B may also contain a tracking information associated with the first user 110 A. The unique identification data 310 B may therefore track both a further reservation activity of the second user 110 B as well as the further reservation activity of the first user 110 B. A third user 110 C may be a member of the social network associated with the second user 110 B and may purchase the ticket through the unique identification information 310 B.

In step 3 of FIG. 5A, the third user 110 C may purchase the ticketed item and pay the ticket price associated with the ticketed item to the payment portal 120. The tracking module 180 may then track the further reservation and may attribute the further reservations to both the second user 110 B and the first user 110 A and may store this information into the accounts 380 of both the second user 110 B and the first user 110 A.

In step 4 of FIG. 5B, after the predetermined duration set by the management server 130 has elapsed, the tracking module may track at least two transactions for the first user 110 A (the further reservation for second user 110 B and the further reservation for third user 110 C). The tracking module may store this information in the user accounts 380 for the second user 110 B and the first user 110 A. In one or more embodiments, the tracking module may trace the further reservation to the first user 110 A and the second user 110 B based on the unique identification data 310 B since the unique identification data 310 B also traces the first user identification data 310 A. In one or more embodiments, all further reservations through the unique identification information 310 B may also be tracked to the first user 110 A since the unique identification information 310 B may also contain the unique identification information 310A. Therefore, in one or more embodiments, if the first user has 3 further reservations and if one of the three users is able to further generate 40 other further reservations, the tracking module may track it as further reservation for the first user 110 A as well, such that, after the predetermined duration has elapsed, the total number of further reservations for the first user 110 A may be 43 (40+3) and the total number of further reservations for the second user 110 B may be 40. In one or more embodiments, the number of further reservations and the visits generated by the unique identification data associated with the first user 110 A may increase proportionally with the number of further reservations and visits generated through members of their social network who have also purchased the ticketed item. The analysis module 140 may calculate the value for the promotional success of the first user 110 A (“X”) and the second user 110 B (“Y”) based on the number of further reservations. In one or more embodiments, the management server may automatically generate a discount and/or return of the ticket price to the first user 110 A and the second user 110 B based on the respective values of the promotional success (“X” and “Y”) after the predetermined duration set by the management server has elapsed.

In one or more embodiments, the management server may a computer and/or a set of a data processing units. In one or more embodiments, the management server may be coupled to a database, a processor and/or a memory. The management server may be accessed through the WAN or any other network.

In one or more embodiments, the set of reservation details may include a set of details about the ticketed item. The set of reservation details may include a name of the ticketed item, a price of the ticketed item, a location of the ticketed item, an expiration date for the ticketed item a quantity of the ticketed item, a set of reviews for the ticketed item and other details. For example, when the ticketed item is for a hotel reservation, the set of reservation details may include the name of the hotel, the price of the hotel reservation, the number of available reservations, an expiration date of the offer for the hotel reservation and any reviews associated with the hotel.

In one or more embodiments, the ticketed item may be any item offered for sale. The ticketed item may be a ticket to an event, a retail commodity, a hotel reservation, an airline ticket, a restaurant reservation and any other type of ticket.

In one or more embodiments, the ticket price associated with the ticketed item may be an offer price of the ticketed item. In one or more embodiments, the user 110 may be able to pay the ticketed price through a virtual currency payment. For example, the user 110 may pay through a payment portal like Paypal®. In one or more embodiments, the user 110 may be able to pay the ticketed price through an inbuilt virtual payment portal. In one or more embodiments, the user may be able to pay the ticket price through cash, check and other conventional payment options.

In one or more embodiments, the discount may be a return of a section or all of the ticket price after the value for the promotional success of the user has been determined. For example, the user may have already paid a ticket price of $100 for the ticketed item. After the predetermined duration has passed, the promotional success of the user may have been high enough such that the payment portal may automatically generate $50 back to the user. In another embodiment, the management server, after evaluating the promotional success of the user, may instead generate a rewards certificate and/or promotional code. For example, in the same example as above, the management server may generate a coupon worth $50 for the user to use in future purchases at the management server or any other retail establishment.

In one or more embodiments, the unique identification data may be a unique URL, a unique identifier redemption code, a unique web address and any other identifier data that may identify and distinguish the user from other users of the system.

In one or more embodiments, the availability notification of the ticketed item may include the set of reservation details concerning the ticketed item and may be in the form of a “story” and/or link that may be posted on a social media webpage. For example, the availability notification of an airline ticket may display a blurb about the deal on the management server and may include the name of the airline, the destination point of the airline ticket, the price of the airline ticket, a quantity of available airline tickets. The first user 110 A may post this availability notification on his “wall” on his Facebook® page for example. The availability notification may also contain an underlying unique URL link and/or embedded unique identifier data such that the second user may instantly be directed to the management server when he clicks on the availability notification.

In one or more embodiments, “publishing” the availability notification on the social media web page may be posting the availability notification on an area of a profile associated with the user such that other users of the social media network may access the profile and be directed to the management server. Publishing may also mean directly posting or writing in the unique identification data on the profile associated with the user on the social media web page, in another example. In another example, the user 110 may simply write a comment or a note on the social media webpage and include a link to the management server along with the unique identification data to “publish” the unique identification data to the social network and members of the social network.

In one or more embodiments, the further reservation of the ticketed item may refer to a reservation of the ticketed item made by the second user after he is directed to the management server through the unique identification data associated with the first user. Therefore, when the second user provides payment to the payment portal for the ticketed item after visiting the management server by clicking on the availability notification of the ticketed item containing the unique identification data associated with the first user, this reservation may be considered a “further reservation” that may be tracked in the account 380 associated with the first user. Similarly, when the second user visits the management server after having been directed to the management server through the unique identification data associated with the first user the tracking module may track the “visit” to the management server in the account 380 associated with the first server. In one or more embodiments, the promotional success of the first user may be a function and/or tally of a total number of further reservations and number of visits to the management server achieved through the unique identification data associated with the first user. Based on at least one of the number of further reservations of the ticketed item and a number of visits to the management server achieved through the unique identification data associated with the first user, the analysis module may generate a value for the promotional success of the first user. In one or more embodiments, this value may be used to calculate a discount for the first user. As discussed above, the analysis module may use an algorithm based on predetermined user preferences and/or system preferences to generate the value for the promotional success of the first user.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software. For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
publishing, through a management server, a set of reservation details associated with a ticketed item;
reserving the ticketed item for a first user when the first user provides payment of the ticketed item to a payment portal through the management server;
generating a first unique identification data associated with the first user on an availability notification of the ticketed item for the first user to publish on a social network;
tracking a further reservation of the ticketed item achieved when a second user, who is a member of the social network, purchases the ticketed item through the first unique identification data associated with the first user;
calculating a value for a promotional success of the first user based on at least one of a number of further reservations tracked through the first unique identification data associated with the first user and the number of visits to the management server through the first unique identification data associated with the first user; and
automatically generating, through the payment portal, a discount to the first user based on the value of the promotional success of the first user.

2. The method of claim 1 further comprising:
when the second user purchases the ticketed item through the unique identification data associated with the first user, generating a second unique identification data associated with the second user that also contains the first unique identification data associated with the first user;
tracing a further reservation of the ticketed item by a third user, who is a member of a social network of the second user, to the first user through the second unique identification data that also contains the first unique identification data associated with the first user; and
increasing the value for the promotional success of the first user and the second user based on the further reservation of the ticketed item by the third user.

3. The method of claim 1 further comprising:
generating a calculated promotional potential of the user based on at least one of a social media worth of the user, a number of contacts at a social media website, a frequency of activity on a social media website, a reputation of the user on the social media website, a number of followers of the user on the social media website, a frequency of visits to the management server, an information obtained from a third party social media analyzer evaluating a social media worth of the user, a number of ticketed items sold through the user, a set of interests associated with the user, a social clout value, a calculated loyalty of the user and other predetermined factors.

4. The method of claim 1 further comprising:
retrieving a social media credential information of the first user;
analyzing, through an analysis module, a promotional potential of the first user based on the social media credential information;
generating a calculated promotional potential of the first user; and
generating an optimized promotional plan for the first user based on the analysis and the calculated promotional potential of the first user.

5. The method of claim 4 wherein the optimized promotional plan is at least one of prompting the first user to publish the first unique identification data on a particular social network at a predetermined interval of time and an automatic publishing of the first unique identification data on the availability notification of the ticketed item on the particular social network.

6. The method of claim 1 further comprising:
setting a predetermined duration for the further reservation of the ticketed item through the management server;
increasing the value for the promotional success of the first user when the further reservation occurs within the predetermined duration; and
keeping the value for the promotional success of the first user the same when the further reservation occurs after the predetermined duration.

7. The method of claim 1 further comprising:
when the value for the promotional success of the first user is greater than a threshold value, converting the discount to a refund of a purchase price of the ticketed item; and
automatically generating the refund, through the payment portal.

8. The method of claim 1 wherein the unique identification data is at least one of a unique URL, a unique web source, a redemption code and a unique bar code.

9. The method of claim 1 wherein the discount to the first user is at least one of a fixed percentage of the ticketed item price, a sliding scale percentage based on the ticketed item price and the value for the promotional success, a credit, a refund of the purchase price of the ticketed item, a predetermined coupon value, a rewards certificate and a predetermined fixed value.

10. The method of claim 1 further comprising:
creating an account for the first user when the first user reserves the ticketed item on the management server;
tracking at least one of a number of further reservations and a number of visits to the management server through the unique identification information associated with the first user;
evaluating the promotional success associated with the first user over a period of time; and
generating a rewards ticket? based on a value of the promotional success of the first user.

11. The method of claim 6 further comprising:
dynamically modifying the promotional success of the first user based on the number of further reservations;
generating the value for the promotional success of the first user at the end of the predetermined duration; and
generating a discount to the first user based on the promotional success of the first user and the end of the predetermined duration.

12. The method of claim 1 further comprising:
automatically determining an availability of a remainder of ticketed items based on a number of reservations.

13. A method comprising:
reserving a ticketed item for a first user when the first user reserves the ticketed through a management server;
generating a first unique identification data associated with the first user on an availability notification of the ticketed item for the first user to publish on a social network;
tracking a further reservation of the ticketed item achieved when a second user, who is a member of the social network, purchases the ticketed item through the first unique identification data associated with the first user;
calculating a value for a promotional success of the first user based on at least one of a number of further reservations tracked through the first unique identification data associated with the first user and the number of visits to the management server through the first unique identification data associated with the first user; and
automatically generating a discounted price, through the payment portal, based on the value of the promotional success of the first user when the first user purchases the ticketed item.

14. The method of claim 13 further comprising:
when the second user purchases the ticketed item through the unique identification data associated with the first user, generating a second unique identification data associated with the second user that also contains the first unique identification data associated with the first user;
tracing a further reservation of the ticketed item by a third user, who is a member of a social network of the second user, to the first user through the second unique identification data that also contains the first unique identification data associated with the first user; and
increasing the value for the promotional success of the first user and the second user based on the further reservation of the ticketed item by the third user.

15. The method claim 13 further comprising:
exclusively tracking at least one of a number of further reservations of the ticketed item achieved through the unique identification information of the first user and a number of visits to the management server through the unique identification information associated with the first user during a predetermined duration set through the management server.

16. The method of claim 14 further comprising:
retrieving a social media credential information of the first user;
analyzing, through an analysis module, a promotional potential of the first user based on the social media credential information;
generating a calculated promotional potential of the first user; and
generating an optimized promotional plan for the first user based on the analysis and the calculated promotional potential of the first user.

17. A system comprising a processor communicatively coupled with a volatile memory and a non-volatile storage further comprising:
a management server:
to publish a set of reservation details associated with a ticketed item;
to reserve the ticketed item when requested by a first user;
to generate a unique identification information associated with the first user;
to track at least one of a number of further reservations of the ticketed item through the unique identification information associated with the first user and a number of further visits to the management server through the unique identification information associated with the first user;
to calculate a value for a promotional success of the first user based on at least one of a number of further reservations of the ticketed item and a number of further visits to the management server through the unique identification information associated with the first user.

18. The system of claim 17 further comprising:
a payment portal:
to automatically generate a discount to the first user based on the value of the promotional success of the first user.

19. The system of claim 17 further comprising:
a payment portal:
to automatically generate a discounted price based on the value of the promotional success of the first user when the first user purchases the ticketed item.

20. The system of claim 17 wherein the management server generates a calculated promotional potential of the user based on at least one of a social media worth of the user, a number of contacts at a social media website, a frequency of activity on a social media website, a reputation of the user on the social media website, a number of followers of the user on the social media website, a frequency of visits to the management server, an information obtained from a third party social media analyzer evaluating a social media worth of the user, a number of tickets sold through the user, a set of interests associated with the user, a social clout value, a calculated loyalty of the user and other predetermined factors.
